(19) United States
(12) Patent Application Publication
(10) Pub. No.: US 2026/0135855 A1
(43) Pub. Date: May 14, 2026

(54) APPARATUS AND METHOD FOR COMMUNICATION SECURITY BASED ON TRANSMITTER IDENTIFICATION

(71) Applicant: ELECTRONICS AND TELECOMMUNICATIONS RESEARCH INSTITUTE, Daejeon (KR)

(72) Inventors: Giha YOON, Daejeon (KR); Geun Yong KIM, Daejeon (KR); Ryangsoo KIM, Daejeon (KR); Sung Chang KIM, Daejeon (KR); Chorwon KIM, Daejeon (KR); Hark YOO, Daejeon (KR)

(73) Assignee: ELECTRONICS AND TELECOMMUNICATIONS RESEARCH INSTITUTE, Daejeon (KR)

(21) Appl. No.: 19/388,357

(22) Filed: Nov. 13, 2025

(30) Foreign Application Priority Data
Nov. 14, 2024 (KR) 10-2024-0162185
Jul. 30, 2025 (KR) 10-2025-0103965

(51) Int. Cl. H04L 9/40

(52) U.S. Cl. CPC H04L 63/104; H04L 63/0218

(57) ABSTRACT

Provided is a communication security apparatus including: a first communication unit that acquires a frame to be transmitted by a first device over a mixed network of an information technology (IT) network and an operation technology (OT) network; a processing unit that processes the frame such that a length variation pattern corresponding to a communication address of the first device from among unique patterns for a plurality of communication addresses is applied; and a second communication unit that transmits the processed frame to a second device through a physical link of the mixed network, wherein the length variation pattern is used for the second device to check whether the received frame is a frame related to unauthorized access after receiving the processed frame through the physical link.

### CROSS-REFERENCE TO RELATED APPLICATION

This application claims priority to and the benefit of Korean Patent Application No. 10-2024-0162185, filed on Nov. 14, 2024, and Korean Patent Application No. 10-2025-0103965, filed on Jul. 30, 2025, the disclosure of which are incorporated herein by reference in its entirety.

### BACKGROUND

### 1. Field of the Invention

Various embodiments disclosed in this document relate to a communication security technology for a mixed network of an operation technology (OT) and an information technology (IT).

### 2. Discussion of Related Art

Recently, with the introduction of IoT devices in various industrial fields, operation technology (OT) and information technology (IT) have been converging over public networks or open networks.

OT refers to hardware and software systems that monitor, and control industrial equipment and processes used to operate critical infrastructure, utilities, power grids, manufacturing plants, traffic control systems, and the like. In the past, IT and OT were present without relying on each other, but in recent years, there has been an increasing number of cases in which OT systems are provisioned through network and computing technologies.

With the establishment of industrial IoT or IIoT, which is a matrix of sensors, instruments, and devices that collect and share data in various industries, such as manufacturing, oil and gas, transportation, and energy/utilities, the two worlds of IT and OT are converging. The integration of IT and OT may provide various benefits, such as improved information flow, process automation, advancement in distributed operation management, and improved regulatory compliance.

However, as parts of interconnected IT/OT systems are exposed to external networks, there is also a risk that hackers may attack such systems through the Internet. Moreover, since IT/OT networks tend to be applied to critical infrastructure, such as energy grids, power plants, water and waste management systems, food processing plants, and transportation networks, the leakage of confidential data may cause not only industrial site losses but also nationwide losses. Therefore, in IT/OT convergent industrial networks, it is required to monitor whether unauthorized or unlicensed communications are connected.

### SUMMARY OF THE INVENTION

Various embodiments disclosed in this document may provide an apparatus and method for communication security based on transmitter identification capable of preventing unauthorized access to an industrial network connected to a commercial Internet network.

According to an aspect of the present invention, there is provided a communication security apparatus, which includes: a first communication unit that acquires a frame to be transmitted by a first device over a mixed network of an information technology (IT) network and an operation technology (OT) network; a processing unit that processes the frame such that a length variation pattern corresponding to a communication address of the first device from among unique patterns for a plurality of communication addresses is applied; and a second communication unit that transmits the processed frame to a second device through a physical link of the mixed network, wherein the length variation pattern is used for the second device to check whether the received frame is a frame related to unauthorized access after receiving the processed frame through the physical link.

According to an aspect of the present invention, there is provided a communication security apparatus, which includes: a first communication unit that receives a frame from a first device through a mixed network of an information technology (IT) network and an operation technology (OT) network; and an analysis unit that checks whether the received frame has a unique length variation pattern corresponding to a transmitter address of the frame among unique patterns for each device communication address, and determines a frame that does not have the unique length variation pattern to be a frame related to unauthorized access.

According to an aspect of the present invention, there is provided a communication security method, which includes: acquiring a frame to be transmitted by a first device over a mixed network of an information technology (IT) network and an operation technology (OT) network; processing the frame such that a length variation pattern corresponding to a communication address of the first device from among unique patterns for a plurality of communication addresses is applied; and transmitting the processed frame to a second device through a physical link of the mixed network, wherein the length variation pattern is used for the second device to check whether the received frame is a frame related to unauthorized access after receiving the processed frame through the physical link.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates a power sector system in which OT and IT protocols are mixed according to an embodiment;

FIG. 2 illustrates a block diagram of a system for communication security based on transmitter identification (hereinafter referred to as a “communication security apparatus”) according to an embodiment;

FIG. 3 illustrates a block diagram of a frame generation unit and a pattern analysis unit;

FIGS. 4 and 5 illustrate examples of applying a unique pattern according to an embodiment;

FIG. 6 illustrates an example of unauthorized access identification based on unique patterns according to an embodiment; and

FIG. 7 illustrates a flowchart of a method for communication security based on transmitter identification according to an embodiment.

In relation to the description of the drawings, identical or similar reference numerals may be used for identical or similar components.

### DETAILED DESCRIPTION OF EXEMPLARY EMBODIMENTS

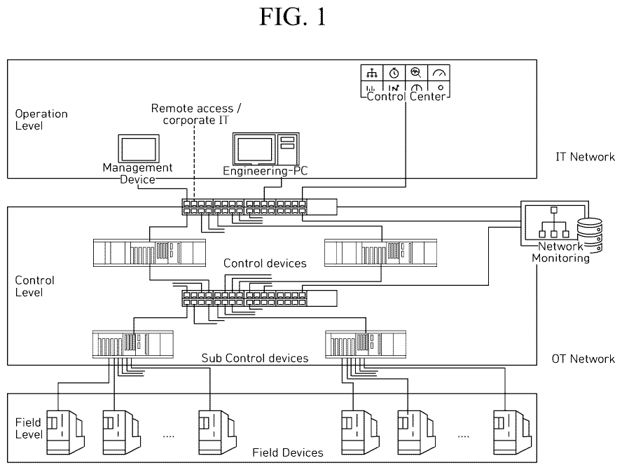

FIG. 1 illustrates a power sector system in which OT and IT protocols are mixed according to an embodiment.

Referring to FIG. 1, a power sector system 100 utilizing an open communication network uses a mixed network including an OT network and an IT network.

As shown in FIG. 1, the operation level of the power sector system 100 may include a management device, engineering PC, and control center equipment. The control level of the power sector system 100 includes a main control device and a sub-control device, and the field level may include a field device.

The power sector system 100 may prepare for unauthorized external access and malicious code attacks from the Internet network based on known methods through a network monitoring device (e.g., a firewall device or a terminal device to which a security policy is applied). For example, the power sector system 100 may introduce a firewall device (network monitoring) at a connection point between a commercial Internet network and its own network (a closed network). As another example, the power sector system 100 may monitor unauthorized external access and malicious code attacks from the Internet network through security policy-based maintenance for each terminal device.

However, in such methods, when a malicious device attempts to connect by mimicking a device that is already connected and operating, it may be difficult to fundamentally block and detect the attack.

In other words, since conventional industrial networks use widely known network protocols in network relay equipment, unauthorized network connections may occur due to access attempts by third parties with malicious intent. In this case, not only may malfunctions or communication errors of OT devices and terminals be caused, but also core corporate/national technologies may be leaked and stolen. Moreover, this issue is an international cybersecurity concern, and its importance and security awareness continue to increase.

However, conventional countermeasures against external intrusions into industrial networks are limited to security management through security and partial maintenance of firewall devices or OT devices and thus may be vulnerable to new types of network intrusions or attacks.

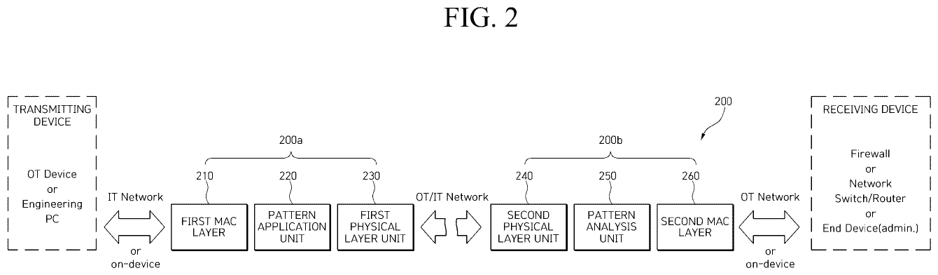

FIG. 2 illustrates a block diagram of a system for communication security based on transmitter identification (hereinafter referred to as a “communication security system”) according to an embodiment.

Referring to FIG. 2, a communication security system 200 according to an embodiment may include a transmitting-side communication security apparatus 200a and a receiving-side communication security apparatus 200b. The transmitting-side communication security apparatus 200a and the receiving-side communication security apparatus 200b may be provided at both ends of a physical link.

According to an embodiment, the transmitting-side communication security apparatus 200a may be connected to a transmitting device that transmits data or may be included in a communication module of the transmitting device. The transmitting device may be, for example, at least one of an operation technology (OT) device or an engineering PC connected to an IT network.

The transmitting-side communication security apparatus 200a may include a first media access control (MAC) layer unit 210, a pattern application unit 220, and a first physical layer unit 230.

The first MAC layer unit 210 may convert a transmission packet acquired from a processor within the transmitting device into a frame. The first MAC layer unit 210 may generate a transmission frame (or a transmit frame) by encapsulating the acquired transmission packets in frame units. Additionally, the first MAC layer unit 210 may further perform channel access control, MAC address designation and identification, transmission scheduling, and retransmission control.

The pattern application unit 220 may generate, store, and manage unique pattern data (a database) that may distinguish devices (e.g., industrial equipment) connected to the mixed network (or industrial network). The unique pattern data may include unique patterns related to at least one pattens of a frame length variation pattern or a transmission interval variation pattern corresponding to a communication address (a MAC Address) of a device.

The pattern application unit 220 may acquire a transmission frame from the first MAC layer unit 210, group transmission frames having the same destination address into units of N frames, and apply a unique pattern for each communication address to each frame within the frame group (or process the transmission frames according to the unique pattern). The value of N may vary depending on the communication address (the MAC Address).

For example, the pattern application unit 220 may check the destination address in the transmission frame and identify the unique pattern corresponding to the destination address among the unique pattern data for each communication address. The pattern application unit 220 may process the transmission frame such that the transmission frame has at least one pattern among a length variation pattern and a transmission interval variation pattern according to the unique pattern.

In this case, the pattern application unit 220 may apply the frame length variation pattern to the transmission frames before processing, in units of N frames (which may hereinafter be referred to as “frame groups”). The pattern application unit 220 may adjust the length of the transmission frame by adding dummy bits or specific values to each frame.

Additionally, the pattern application unit 220 may further apply a transmission interval pattern to the frames within the frame group. For example, when the mixed network is a communication network to which a time-sensitive networking (TSN) technology based on precise time synchronization is applied, the pattern application unit 220 may apply a transmission interval pattern by applying a transmission time of each frame, or a scheduled transmission time (an egress timestamp) of each frame and a time value variation between frames.

The pattern application unit 220 may group frames for each destination address and apply a unique pattern according to a communication address to the grouped frames (processed frames) and transfer the processed frames to the first physical layer unit 230.

The first physical layer unit 230 may convert the processed frames into electrical signals and transmit the converted signals through the physical link (the mixed network).

According to an embodiment, the receiving-side communication security apparatus 200b may be connected to a receiving device that receives data or may be included in a communication module of the receiving device. The receiving device may be, for example, a relay device (e.g., a network switch, a network router, and the like) between an IT network and an OT network, or a firewall device (e.g., a firewall). Alternatively, the receiving device may include a terminal device of the OT network.

The receiving-side communication security apparatus 200b may include a second physical layer unit 240, a pattern analysis unit 250, and a second MAC layer unit 260.

The second physical layer unit 240 may acquire electrical transmission signals transmitted from the transmitting-side communication security apparatus 200a through the physical link and convert the acquired electrical signals into frames.

The pattern analysis unit 250 may acquire the frames received from the second physical layer unit 240 and identify the transmitter (transmitting device) address from the acquired frames.

The pattern analysis unit 250 may check whether the received frames are configured with a unique pattern corresponding to the transmitter address based on the unique pattern data. For example, when the unique pattern corresponding to the transmitter address includes a first length variation pattern and a first transmission interval variation pattern, the pattern analysis unit 250 may check whether the acquired frames have the first length variation pattern and the first transmission interval variation pattern. When the acquired frames have the first length variation pattern and the first transmission interval variation pattern, the pattern analysis unit 250 may determine the acquired frames to be legitimate frames. In this regard, the pattern analysis unit 250 may acquire unique pattern data corresponding to communication addresses of each device from an internal memory or a memory which the pattern analysis unit 250 may access and may check unique pattern corresponding to the transmitter address from unique pattern data.

When it is checked that the acquired frames are not configured with the unique pattern corresponding to the transmitter address, the pattern analysis unit 250 may determine that the acquired frames are frames related to unauthorized access.

The pattern analysis unit 250 may block the acquired frames without transferring the frames to the second MAC layer unit 260 upon determination that the acquired frames are frames related to unauthorized access (illegitimate frames). Additionally, the pattern analysis unit 250 may notify the processor of the receiving device of the occurrence of unauthorized access. Accordingly, the pattern analysis unit 250 may block unauthorized access via an open network (e.g., IT networks) in the mixed network of IT and OT and selectively transfer only frames related to authorized access to the second MAC layer unit 260.

The second MAC layer unit 260 may receive only legitimate frames selected by the pattern analysis unit 250, convert the received frames into packets and transfer the packets to the processor of the receiving device.

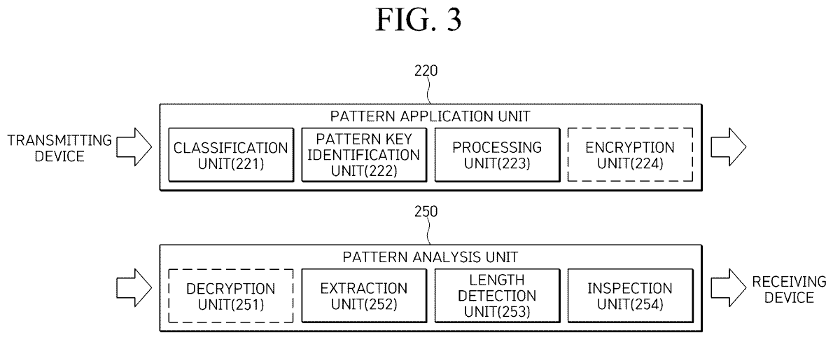

FIG. 3 illustrates a block diagram of a frame generation unit and a pattern analysis unit.

Referring to FIG. 3, the pattern application unit 220 and the pattern analysis unit 250 may be connected between physical links of the mixed network.

The pattern application unit 220 may include a classification unit 221, a pattern key identification unit 222, a processing unit 223, and an encryption unit 224. The classification unit 221, the pattern key identification unit 222, the processing unit 223, and the encryption unit 224 may be included in a processor or may be a software module or a hardware module executed by a processor. At least one of the classification unit 221, the pattern key identification unit 222, the processing unit 223, and the encryption unit 224 may be omitted or integrated into another component.

The classification unit 221 may check the destination address from a frame to be transmitted (hereinafter, a transmission frame) and classify transmission frames by destination address.

The pattern key identification unit 222 may identify a unique pattern corresponding to a transmitter address based on unique pattern data. The unique pattern data may include at least one unique pattern among a frame length variation pattern or a transmission interval variation pattern, for each transmitter address. The pattern key identification unit 222 may grouped frames (or frame group) to be transmitted to the same destination address into units of N frames according to the identified unique pattern, to generate a frame group and transfer the frame group to the processing unit 223.

The processing unit 223 may acquire the frame group from the pattern key identification unit 222 and process each frame such that the unique pattern corresponding to the transmitter address is applied to each frame within the frame group. For example, the processing unit 223 may assign the unique pattern corresponding to the transmitter address on a frame group basis by adjusting the length of each frame or adjusting the transmission interval (the time interval) between frames. As another example, the processing unit 223 may insert padding values into a frame to process the frame length. The padding value may be at least one of dummy bits (bit values that are all 0 or all 1), a specific pattern, or a specific value (a value with a designated sequence).

The encryption unit 224 may encrypt at least some of the processed frames and transfer the encrypted frames to the first physical layer unit 230. For example, the encryption unit 224 may encrypt the padding values added for length adjustment of each frame to process the frames such that an extension value of a specific pattern value is included in each frame. Accordingly, the encryption unit 224 may prevent exposure of the padding values added to each frame for frame length or interval adjustment.

The pattern analysis unit 250 may include a decryption unit 251, an extraction unit 252, a length detection unit 253, and an inspection unit 254. The decryption unit 251, the extraction unit 252, the length detection unit 253, and the inspection unit 254 may be included in a processor or may be a software module or a hardware module executed by a processor. At least one of the decryption unit 251, the extraction unit 252, the length detection unit 253, and the inspection unit 254 may be omitted or integrated into another component.

The decryption unit 251 acquires received frames from the second physical layer unit 240 and decrypts (decodes) the acquired frames. For example, the decryption unit 251 may decrypt the padding values added to each frame.

The extraction unit 252 may acquire the decrypted frames and extract the transmitter address from the acquired frames.

The length detection unit 253 may recognize the starting point of the frame based on a frame header (or a preamble), detect the length of each frame, and provide length information of each frame to the inspection unit 254. Additionally, the length detection unit 253 may identify a frame count unit of the unique pattern corresponding to the transmitter address based on the unique pattern data and output a frame group formed by grouping the frames into the frame count unit.

The inspection unit 254 may acquire each frame and length information in units of frame groups from the length detection unit 253 and analyze the length variation pattern of frames within the frame group. For example, the inspection unit 254 may detect the frame length and the time interval between frames within the frame group and analyze whether the detected length variation and the time interval variation match the unique pattern corresponding to the transmitter address. In this regard, the inspection unit 254 may identify the unique pattern (the length variation pattern and the time interval pattern) corresponding to the transmitter address based on the unique pattern data stored in the memory.

The inspection unit 254 may determine a frame group configured with the unique pattern corresponding to the transmitter address as frames related to authorized access (legitimate frames). On the other hand, when frames within frame groups are not configured with the unique pattern, the inspection unit 254 may determine that the frames are related to unauthorized access (illegitimate frames) and notify the processor of the receiving device.

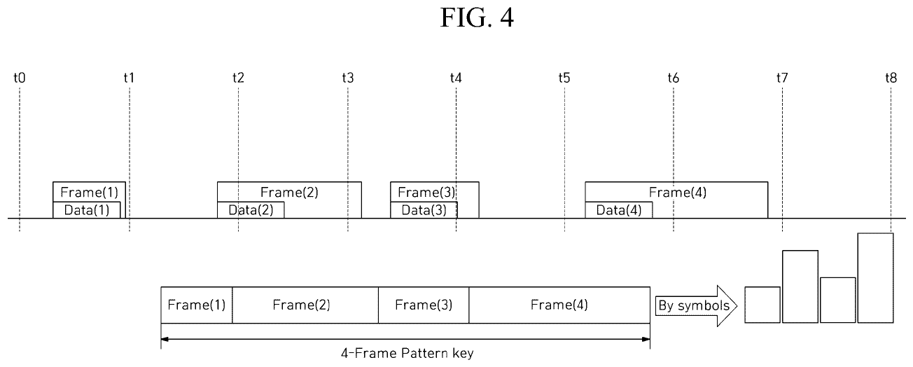

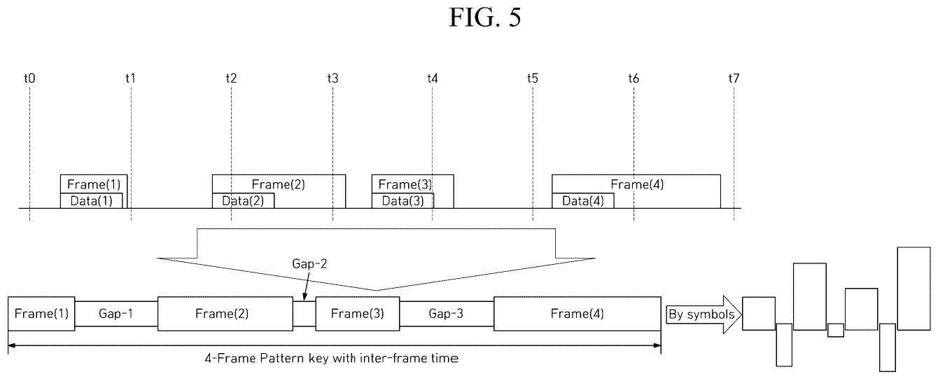

FIGS. 4 and 5 illustrate examples of applying a unique pattern according to an embodiment.

Referring to FIG. 4, the pattern application unit 220 may assign a unique pattern related to each frame length variation in units of N frames (frame groups) according to the destination address DA. For example, when N is 4, the pattern application unit 220 may assign a frame length variation pattern corresponding to a communication address (MAC address) for each device by adjusting a transmission time or a size value in bits (or bytes) of each frame from the first frame to the fourth frame. In this regard, the pattern application unit 220 may adjust the interval of an actual transmission frame (data payload) by adding (or inserting) a designated value next to the data payload included in the frame. The designated value may include, for example, at least one of a dummy value (all values of 0 or 1 bit), a specific pattern or value, or an encryption value of an extension value of a specific pattern value.

Referring to FIG. 5, the pattern application unit 220 may apply a length variation pattern and a transmission interval variation pattern to frames within a frame group corresponding to the destination address. For example, when a frame group includes the first to fourth frames Frame(1)˜Frame(4), the pattern application unit 220 may process the length variation of the first to fourth frames Frame(1)˜Frame(4) and the variation of the transmission intervals Gap-1, Gap-2, and Gap-3 between each of the first to fourth frames Frame(1)˜Frame(4) to have a unique pattern according to the destination address.

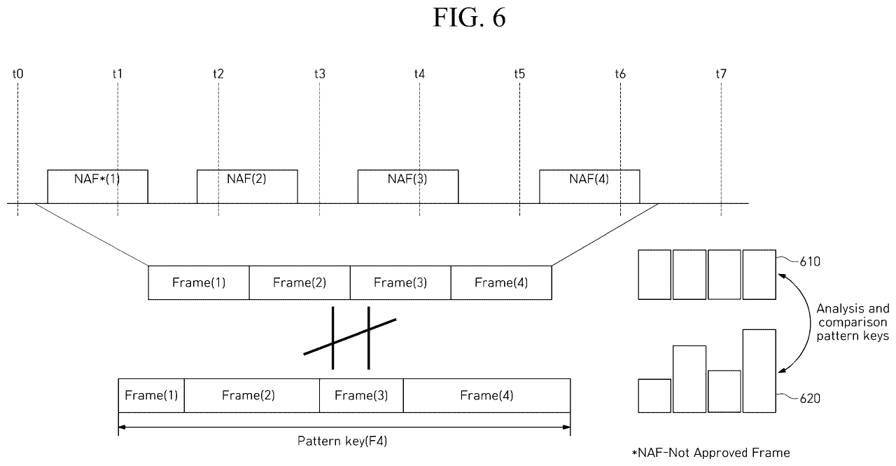

FIG. 6 illustrates an example of unauthorized access identification based on unique patterns according to an embodiment.

Referring to FIG. 6, the unique pattern according to the transmitter address may have a designated length variation pattern 620 in units of four frames. In this case, the pattern analysis unit 250 may check that a frame length variation pattern in units of four frames of the received frames is different from the length variation pattern in units of four frames corresponding to the transmitter address that is pre-registered (stored) to determine the received frames to be unauthorized access frames. For example, in received frames, the lengths of all frames in a four-frame unit are the same, but in the pre-registered unique pattern corresponding to the transmitter address, the lengths in the four-frame unit have a designated variation. Therefore, by checking such a difference, the pattern analysis unit 250 may determine the received frames to be frames related to unauthorized access.

The communication security apparatuses 200a and 200b according to an embodiment may apply a unique packet key to each device that is always operating on the communication network to monitor and manage data transmission and reception of the devices through the communication network, thereby enabling real-time identification and detection of packet intrusion generated from unauthorized devices illegally connected to the operating communication network. Furthermore, the communication security apparatuses 200a and 200b according to an embodiment may rapidly respond to a connection of a new device or a new data flow by monitoring whether a unique pattern is applied.

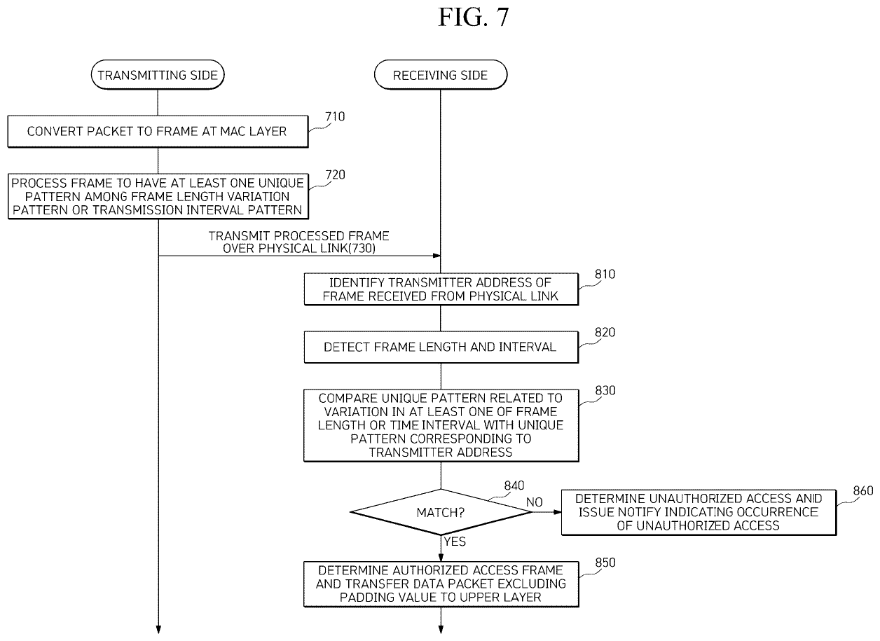

FIG. 7 illustrates a flowchart of a method for communication security based on transmitter identification according to an embodiment.

In operation 710, the transmitting-side communication security apparatus 200a may, upon acquiring a packet to be transmitted from a transmitting device to a mixed network of an IT network and an OT network, convert the packet into a frame. In this case, the transmitting-side communication security apparatus 200a may acquire the frame from a transmitting device that is connected to the IT network and accesses the OT network.

In operation 720, the transmitting-side communication security apparatus 200a may process the frames such that a length variation pattern corresponding to a communication address (hereinafter, a first communication address) of the transmitting device (a first device) among unique patterns for a plurality of communication addresses is applied. Additionally, the transmitting-side communication security apparatus 200a may process the frames such that a transmission interval variation pattern of frames corresponding to the first communication address is further applied. In this case, the transmitting-side communication security apparatus 200a may group frames into a frame count unit corresponding to the first communication address and sequentially apply the length variation pattern to the frames included in the frame groups and may apply the time interval pattern.

For example, the transmitting-side communication security apparatus 200a may apply the length variation pattern by at least one methods of adding dummy bits to each frame, inserting a specific pattern or a specific value, and encryption such that an extension value of a specific pattern value is included.

In operation 730, the transmitting-side communication security apparatus 200a may transmit the processed frames to a receiving device through the physical links of the mixed network. For example, the transmitting-side communication security apparatus 200a may transmit the processed frames to a receiving device including at least one of a relay device between IT and OT networks, a firewall device, or a terminal device of the OT network.

In operation 730, the receiving-side communication security apparatus 200b may receive the frames transmitted from the transmitting device and processed by the transmitting-side communication security apparatus 200a from the physical link of the mixed network.

In operation 810, the receiving-side communication security apparatus 200b may identify (or extract) the transmitter address from the received frames.

In operation 820, the receiving-side communication security apparatus 200b may detect the frame length and the transmission interval.

In operation 830, the receiving-side communication security apparatus 200b may compare variations in the length and the transmission interval of each of the received frames with the length variation pattern and the transmission interval variation pattern corresponding to the transmitter address.

In operation 840, the receiving-side communication security apparatus 200b may check whether variations in the length and the transmission interval of the received frames match the length variation pattern and the transmission interval variation pattern corresponding to the transmitter address.

In operation 840, when variations in the length and the transmission interval of the received frames match the length variation pattern and the transmission interval variation pattern corresponding to the transmitter address, the receiving-side communication security apparatus 200b may determine the received frames to be frames related to authorized access (legitimate frames) in operation 850. When the received frames are determined to be frames related to authorized access (legitimate frames), the receiving-side communication security apparatus 200b may convert the frames into packets after removing padding bits added for length variations from the received frames and transfer the frames to an upper layer.

In operation 840, when variations in the length and the transmission interval of the received frames do not match the length variation pattern and the transmission interval variation pattern corresponding to the transmitter address, the receiving-side communication security apparatus 200b may determine the received frames to be frames related to unauthorized access and issue an notify indicating the occurrence of unauthorized access in operation 860.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a” and “an” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” or “at least one of A, B, or C” may include any one of the items listed together in the corresponding phrase, or any possible combination thereof. Terms such as “first,” “second,” etc., are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” A module may be an integrally formed component or a minimum unit or part of an integrally formed component that performs one or more functions. For example, according to an embodiment, a module may be implemented in the form of an application-specific integrated circuit (ASIC).

The various embodiments of the present disclosure may be realized by software (e.g., a program) including one or more instructions stored in a storage medium (e.g., an internal memory or external memory, a memory (not shown)) that may be read by a machine (e.g., an electronic device). For example, a processor (e.g., the pattern application unit 220 or the pattern analysis unit 250) of the machine (e.g., the communication security apparatuses 200b and 200b) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it may be understood that the storage medium is tangible and does not include a signal (for example, electromagnetic waves), but rather that data is semi-permanently or temporarily stored in the storage medium.

According to an embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure may be implemented in the form of software or hardware, such as a digital signal processor (DSP), a field-programmable gate array (FPGA) or an ASIC and may perform predetermined functions. The term “elements” is not limited to meaning software or hardware. Each of the elements may be stored in a storage medium capable of being addressed and configured to execute one or more processors. For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

According to various embodiments disclosed in this document, unauthorized access to an industrial network connected to a commercial Internet network can be prevented. In addition, various effects that are directly or indirectly identified through this document may be provided.

What is claimed is:

1. A communication security apparatus comprising:
a first communication unit that acquires a frame to be transmitted by a first device over a mixed network of an information technology (IT) network and an operation technology (OT) network;
a processing unit that processes the frame such that a length variation pattern corresponding to a communication address of the first device from among unique patterns for a plurality of communication addresses is applied; and
a second communication unit that transmits the processed frame to a second device through a physical link of the mixed network,
wherein the length variation pattern is used for the second device to check whether the received frame is a frame related to unauthorized access after receiving the processed frame through the physical link.

2. The communication security apparatus of claim 1, wherein the first device is a device connected to the IT network and accessing the OT network, and
the second device includes at least one device of a relay device or a firewall device between the IT network and the OT network, or a terminal device of the OT network.

3. The communication security apparatus of claim 1, wherein the processing unit is configured to:
acquire a length variation pattern corresponding to the communication address of the first device from a memory storing the unique patterns for each communication address, and
use the acquired length variation pattern for processing the frame.

4. The communication security apparatus of claim 1, wherein the processing unit groups frames into a frame count unit corresponding to the communication address and sequentially applies the length variation pattern to frames within the frames grouped.

5. The communication security apparatus of claim 4, wherein the unique patterns for each communication address further include a time interval variation pattern corresponding to the communication address of the first device, and
the processing unit further applies the time interval variation pattern corresponding to the communication address of the first device to the frames within the frames grouped to further process the frames.

6. The communication security apparatus of claim 1, wherein the processing unit applies the length variation pattern by at least one methods of adding dummy bits to each frame, inserting a specific pattern or a specific value, and encryption such that an extension value of a specific pattern value is included.

7. A communication security apparatus comprising:
a first communication unit that receives a frame from a first device through a mixed network of an information technology (IT) network and an operation technology (OT) network; and
an analysis unit that checks whether the received frame has a unique length variation pattern corresponding to a transmitter address of the frame among unique patterns for each device communication address and determines a frame that does not have the unique length variation pattern to be a frame related to unauthorized access.

8. The communication security apparatus of claim 7, wherein the analysis unit checks a frame count unit corresponding to the transmitter address and checks a length variation pattern about frames of the frame count unit.

9. The communication security apparatus of claim 7, wherein the unique patterns for each communication address further include a time interval variation pattern corresponding to the transmitter address, and
the analysis unit checks a time interval variation about frames of the frame count unit corresponding to the transmitter address and compares the checked time interval variation with the time interval variation pattern to check whether the frames are frames related to unauthorized access.

10. The communication security apparatus of claim 7, wherein the analysis unit, when the received frames have the length variation pattern corresponding to the transmitter address, determines that the received frames are frames related to authorized access, removes a padding bit added for length variation from the received frames, converts the frames into a packet, and transfers the packet to an upper layer.

11. The communication security apparatus of claim 7, wherein the analysis unit, upon detecting the frame related to unauthorized access, outputs an notify about the unauthorized access.

12. A communication security method comprising:
acquiring a frame to be transmitted by a first device over a mixed network of an information technology (IT) network and an operation technology (OT) network; and
processing the frame such that a length variation pattern corresponding to a communication address of the first device from among unique patterns for a plurality of communication addresses is applied; and
transmitting the processed frame to a second device through a physical link of the mixed network,
wherein the length variation pattern is used for the second device to check whether the received frame is a frame related to unauthorized access after receiving the processed frame through the physical link.

13. The communication security method of claim 12, wherein the acquiring of the frame includes acquiring the frame from the first device connected to the IT network and accessing the OT network.

14. The communication security method of claim 12, wherein the transmitting of the processed frame includes transmitting to the second device including at least one of a relay device or a firewall device between the IT network and the OT network, or a terminal device of the OT network.

15. The communication security method of claim 12, wherein the processing of the frame includes:
identifying a length variation pattern corresponding to the communication address of the first device from a memory storing the unique patterns for each communication address; and
processing the frame such that the identified length variation pattern is applied to the frame.

16. The communication security method of claim 12, wherein the processing of the frame includes:
grouping frames into a frame count unit corresponding to the communication address; and
sequentially applying the length variation pattern to frames within the frames grouped.

17. The communication security method of claim 16, wherein the unique patterns for each communication address further include a time interval variation pattern corresponding to the communication address of the first device, and
the processing of the frame further includes processing the frames such that the time interval variation pattern corresponding to the communication address of the first device is applied to the frames within the frames grouped.

18. The communication security method of claim 12, wherein the processing of the frame includes applying the length variation pattern by at least one methods of adding dummy bits to each frame, inserting a specific pattern or a specific value, and encryption such that an extension value of a specific pattern value is included.

19. The communication security method of claim 12, further comprising:
receiving the frame from the first device through the mixed network;
analyzing whether the received frame has a length variation pattern corresponding to a transmitter address identified from the frame among unique patterns for each device communication address; and
determining the received frame to be a frame related to unauthorized access when the received frame does not have the length variation pattern.

20. The communication security method of claim 19, wherein the analyzing of the received frames further includes:
when the received frames have a length variation that matches the length variation pattern corresponding to the transmitter address, determining that the received frames are frames related to authorized access; and
removing a padding bit added for length variation from the received frames, converting the frames into a packet, and transferring the packet to an upper layer.
